(19) United States
(12) Patent Application Publication
(10) Pub. No.: US 2026/0080713 A1
(43) Pub. Date: Mar. 19, 2026

(54) OPTIMIZED DATA TRANSFER BETWEEN SYSTEMS CONNECTED OVER A NETWORK

(71) Applicant: Samsung Electronics Co., Ltd., Suwon-si (KR)

(72) Inventors: Mallikarjun Swamy, Sunnyvale, CA (US); Naga R. Kandregula, San Jose, CA (US); Siva Boggala, San Ramon, CA (US)

(21) Appl. No.: 19/198,468

(22) Filed: May 5, 2025

Related U.S. Application Data
(60) Provisional application No. 63/696,646, filed on Sep. 19, 2024.

(51) Int. Cl. G06V 40/18; G06F 3/01; G06T 7/11; G06T 9/00

(52) U.S. Cl. CPC G06V 40/193; G06F 3/013; G06T 7/11; G06T 9/00

(57) ABSTRACT

A method includes obtaining, using at least one processing device of a first electronic device, a source image; dividing, using the at least one processing device, the source image into a source foveal region and a source peripheral region in a normalized coordinate space having a first range, wherein a center of the source foveal region is not aligned with a center of the normalized coordinate space; uncompressing, using the at least one processing device, the source image into a destination foveal region and a destination peripheral region in a destination coordinate space, wherein the source foveal region is preserved and the source peripheral region is uncompressed in a non-uniform manner based on an inverse falloff function; and displaying the uncompressed source image.

### CROSS-REFERENCE TO RELATED APPLICATION AND PRIORITY CLAIM

This application claims priority under 35 U.S.C. § 119(e) to U.S. Provisional Patent Application No. 63/696,646 filed on Sep. 19, 2024, which is hereby incorporated by reference in its entirety.

### TECHNICAL FIELD

This disclosure relates generally to data transfer systems and processes. More specifically, this disclosure relates to optimized data transfer between systems connected over a network.

### BACKGROUND

Extended reality (XR) systems are becoming more and more popular over time, and numerous applications have been and are being developed for XR systems. Some XR systems (such as augmented reality or “AR” systems and mixed reality or “MR” systems) can enhance a user's view of his or her current environment by overlaying digital content (such as information or virtual objects) over the user's view of the current environment. For example, some XR systems can often seamlessly blend virtual objects generated by computer graphics with real-world scenes.

### SUMMARY

This disclosure relates to an optimized data transfer between systems connected over a network.

In a first embodiment, a method includes obtaining, using at least one processing device of a first electronic device, a source image. The method also includes dividing, using the at least one processing device, the source image into a source foveal region and a source peripheral region in a normalized coordinate space having a first range, where a center of the source foveal region is not aligned with a center of the normalized coordinate space. The method further includes uncompressing, using the at least one processing device, the source image into a destination foveal region and a destination peripheral region in a destination coordinate space, where the source foveal region is preserved and the source peripheral region is uncompressed in a non-uniform manner based on an inverse falloff function. In addition, the method includes displaying the uncompressed source image. In other embodiments, a non-transitory machine readable medium contains instructions that when executed cause at least one processor to perform the method of the first embodiment.

In a second embodiment, an electronic device includes at least one processing device configured to obtain a source image and divide the source image into a source foveal region and a source peripheral region in a normalized coordinate space having a first range, where a center of the source foveal region is not aligned with a center of the normalized coordinate space. The at least one processing device is also configured to uncompress the source image into a destination foveal region and a destination peripheral region in a destination coordinate space, where the source foveal region is preserved and the source peripheral region is uncompressed in a non-uniform manner based on an inverse falloff function. In addition, the at least one processing device is configured to initiate display of the uncompressed source image.

Any one or any combination of the following features may be used with the first or second embodiment. The source image may be uncompressed by obtaining a source foveal region size, a source foveal region shift from the center of the normalized coordinate space, a destination foveal region size, and a destination foveal region shift from a center of the destination coordinate space; transforming an input destination coordinate space having the first range into a target destination coordinate space; converting source coordinates and destination coordinates to polar coordinates including a source radius and a source angle for each source pixel and a destination radius and a destination angle for each destination pixel; identifying, for each source pixel, a source center distance between the center of the source foveal region and a point at a source foveal region boundary; identifying, for each destination pixel, a destination center distance between a center of the destination foveal region and a point at a destination foveal region boundary; comparing a destination radius of each destination pixel to the destination center distance; and mapping each source pixel from the source image to a corresponding destination pixel in the target destination coordinate space based on at least one of the comparison and the inverse falloff function. Each source pixel may be mapped to the corresponding destination pixel by, for each destination pixel having the destination radius less than the destination center distance, determining a source pixel having a corresponding source radius and a corresponding source angle in the source image and mapping the source pixel to the destination pixel. Each source pixel may be mapped to the corresponding destination pixel by, for each destination pixel having the destination radius greater than the destination center distance, identifying an outer destination distance between the destination pixel and the point at the destination foveal region boundary; identifying a peripheral destination distance between the destination pixel and a point at a destination coordinate space boundary; identifying a normalized outer destination distance based on the outer destination distance and the peripheral destination distance; identifying a normalized outer source distance based on the normalized outer destination distance and the inverse falloff function; identifying a source radius based on the source center distance and the normalized outer source distance; converting the source radius and a corresponding source angle equal to the destination angle of the destination pixel into a Cartesian coordinate; selecting a corresponding source pixel from the source image based on the Cartesian coordinate; and mapping the corresponding source pixel to the destination pixel. The source image may be uncompressed by applying one of a linear falloff function or a polynomial-based falloff function to the destination peripheral region. The destination peripheral region may incorporate one or more lens distortion parameters for the inverse falloff function. The source foveal region may be adjusted based on eye gaze tracking data. Each of the source foveal region and the destination foveal region may have an elliptical or polygonal shape.

In a third embodiment, a method includes obtaining, using at least one processing device of a first electronic device, a source image. The method also includes, using the at least one processing device, dividing the source image into a source foveal region and a source peripheral region in a normalized coordinate space having a first range, where a center of the source foveal region is not aligned with a center of the normalized coordinate space. The method further includes compressing, using the at least one processing device, the source image into a destination foveal region and a destination peripheral region in a destination coordinate space, where the source foveal region remains uncompressed and the source peripheral region is compressed in a non-uniform manner based on a falloff function. In addition, the method includes transferring, to a second electronic device, the compressed source image. In other embodiments, an electronic device includes at least one processing device configured to perform the method of the first embodiment. In still other embodiments, a non-transitory machine readable medium contains instructions that when executed cause at least one processor to perform the method of the first embodiment.

Any one or any combination of the following features may be used with the third embodiment. The source image may be compressed by obtaining a source foveal region size, a source foveal region shift from the center of the normalized coordinate space, a destination foveal region size, and a destination foveal region shift from a center of the destination coordinate space; transforming an input destination coordinate space having the first range into a target destination coordinate space; converting source coordinates and destination coordinates to polar coordinates including a source radius and a source angle for each source pixel and a destination radius and a destination angle for each destination pixel; identifying, for each source pixel, a source center distance between the center of the source foveal region and a point at a source foveal region boundary; identifying, for each destination pixel, a destination center distance between a center of the destination foveal region and a point at a destination foveal region boundary; comparing a destination radius of each destination pixel to the destination center distance; and mapping each source pixel from the source image to a corresponding destination pixel in the target destination coordinate space based on at least one of the comparison and the falloff function. Each source pixel may be mapped to the corresponding destination pixel by, for each destination pixel having the destination radius less than the destination center distance, determining a source pixel having a corresponding source radius and a corresponding source angle in the source image and mapping the source pixel to the destination pixel without compression. Each source pixel may be mapped to the corresponding destination pixel by, for each destination pixel having the destination radius greater than the destination center distance, identifying an outer destination distance between the destination pixel and the point at the destination foveal region boundary; identifying a peripheral destination distance between the destination pixel and a point at a destination coordinate space boundary; identifying a normalized outer destination distance based on the outer destination distance and the peripheral destination distance; identifying a normalized outer source distance based on the normalized outer destination distance and the falloff function; identifying a source radius based on the source center distance and the normalized outer source distance; converting the source radius and a corresponding source angle equal to the destination angle of the destination pixel into a Cartesian coordinate; selecting a corresponding source pixel from the source image based on the Cartesian coordinate; and mapping the corresponding source pixel to the destination pixel. The source image may be compressed by applying one of a linear falloff function or a polynomial-based falloff function to the destination peripheral region. The destination peripheral region may incorporate one or more lens distortion parameters for the inverse falloff function. The source foveal region may be adjusted based on eye gaze tracking data. Each of the source foveal region and the destination foveal region may have an elliptical or polygonal shape.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include any other electronic devices now known or later developed.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which:

FIG. 1 illustrates an example network configuration including an electronic device in accordance with this disclosure;

FIG. 2 illustrates an example process for optimized data transfer between systems connected over a network in accordance with this disclosure;

FIGS. 3A through 3C illustrate example processes for optimized data transfer between systems connected over a network in accordance with this disclosure;

FIGS. 4A through 4C illustrate an example method for optimized data transfer between systems connected over a network in accordance with this disclosure;

FIGS. 5A through 5E illustrate example steps of the method of FIGS. 4A through 4C in accordance with this disclosure;

FIGS. 6A and 6B illustrate example falloff and inverse falloff functions utilized in the optimized data transfer between systems connected over a network in accordance with this disclosure;

FIG. 7 illustrates an example method for uncompressing a compressed image transferred between systems in a network in accordance with this disclosure; and

FIG. 8 illustrates an example method for compressing an image to be transferred between systems in a network in accordance with this disclosure.

### DETAILED DESCRIPTION

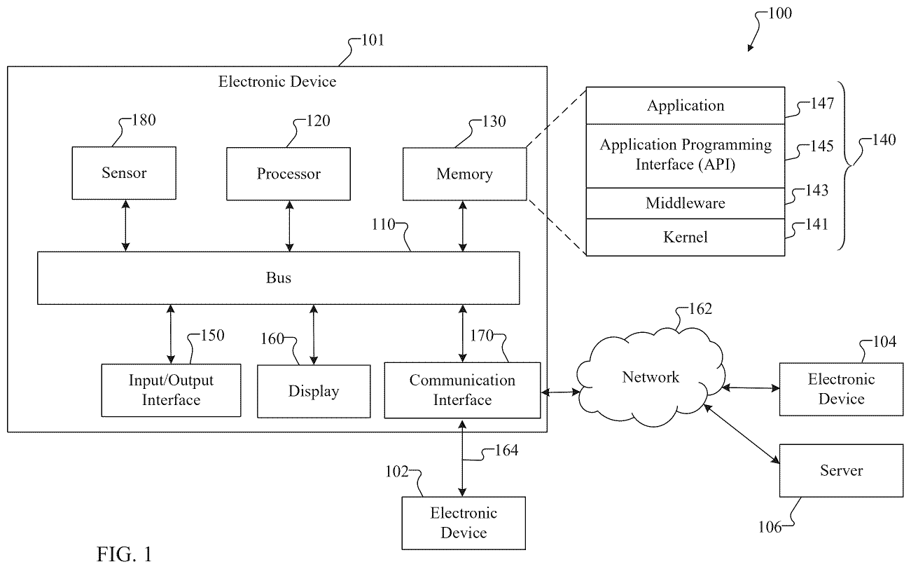

FIGS. 1 through 8, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, extended reality (XR) systems are becoming more and more popular over time, and numerous applications have been and are being developed for XR systems. Some XR systems (such as augmented reality or “AR” systems and mixed reality or “MR” systems) can enhance a user's view of his or her current environment by overlaying digital content (such as information or virtual objects) over the user's view of the current environment. For example, some XR systems can often seamlessly blend virtual objects generated by computer graphics with real-world scenes.

Optical see-through (OST) XR systems refer to XR systems in which users directly view real-world scenes through head-mounted devices (HMDs). Unfortunately, OST XR systems face many challenges that can limit their adoption. Some of these challenges include limited fields of view, limited usage spaces (such as indoor-only usage), failure to display fully-opaque black objects, and usage of complicated optical pipelines that may require projectors, waveguides, and other optical elements. In contrast to OST XR systems, video sec-through (VST) XR systems (also called “passthrough” XR systems) present users with generated video sequences of real-world scenes. VST XR systems can be built using virtual reality (VR) technologies and can have various advantages over OST XR systems. For example, VST XR systems can provide wider fields of view and can provide improved contextual augmented reality.

Unfortunately, users often consume and experience XR content generated on a remote system over a bandwidth-limited network connection. Furthermore, the XR content may be presented to a user in a visual field where the primary visual focus of the user mainly remains in a specific area, while the content in the margin often contributes little to the user experience. In addition, when transferring data over a network, the network transmission may involve compressing an image to a smaller size on the sender side before streaming the image to a recipient side over the network, as well as uncompressing the compressed image at the recipient side for streaming. Such compression may lead to data loss during compression-uncompression, such as in regions that are clearly visible to the user (like a center or foveal region), and the runtime performance cost of an uncompression algorithm may be high.

This disclosure provides various techniques supporting optimized data transfer between systems connected over a network. As described in more detail below, an optimized data transfer can be achieved by applying a symmetric algorithm for compression and uncompression, thereby providing flexibility to switch performance and avoid performance bottlenecks between two systems. To implement a fully or substantially symmetric algorithm for both data compression and data uncompression, this disclosure ensures that the same operations can be performed at both ends of a communication channel. This means that the two systems can use the same algorithm and parameters for both data compression and data uncompression operations. For example, if one system has limited processing power, a less complex algorithm for uncompression can be selected at that system, while a more complex algorithm can be used at the other system. In this way, the overall workflow can be optimized based on available resources and requirements.

Moreover, the optimized data transfer of this disclosure allows adjusting a range of an input destination coordinate space, thereby rendering relevant calculations simpler. This helps with decoupling of, for example, a falloff function. Decoupling the falloff function from core radial compression logic can involve separating the two so that they can be controlled independently. In some cases, the radial compression logic allows for a one-dimensional function to be used as a falloff. This may significantly simplify the falloff function tuning workflow without sacrificing the efficacy of the falloff function. Furthermore, the falloff function can be normalized, such as to have a domain and range of [0, 1]. Normalizing the domain and range can allow users to create a more flexible and controllable falloff effect. With the normalized values, the intensity and shape of the falloff curve can be easily adjusted while reducing or avoiding any visual artifacts induced by the underlying compression logic. Thus, the falloff function can be manipulated to achieve the desired visual result by the decoupling.

In addition, the optimized data transfer of this disclosure may utilize an optimized lossy image compression approach in order to preserve the visual fidelity of a configurable center (foveal) region in images at the expense of margin or peripheral regions, which contribute little to the user experience. In some embodiments, this approach may be targeted to operate as a shader on a graphics processing unit (GPU) and avoid evaluation of costly trigonometric functions.

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, and a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), a graphics processor unit (GPU), or a neural processing unit (NPU). The processor 120 is able to perform control on at least one of the other components of the electronic device 101 and/or perform an operation or data processing relating to communication or other functions. As described below, the processor 120 may perform one or more functions related to an optimized data transfer between systems connected over a network.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may include one or more applications that, among other things, perform optimized data transfer between systems connected over a network. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, the sensor(s) 180 can include cameras or other imaging sensors, which may be used to capture image frames of scenes. The sensor(s) 180 can also include one or more buttons for touch input, one or more microphones, a depth sensor, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. Moreover, the sensor(s) 180 can include one or more position sensors, such as an inertial measurement unit that can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the electronic device 101 can be a wearable device or an electronic device-mountable wearable device (such as an HMD). For example, the electronic device 101 may represent an XR wearable device, such as a headset or smart eyeglasses. In other embodiments, the first external electronic device 102 or the second external electronic device 104 can be a wearable device or an electronic device-mountable wearable device (such as an HMD). In those other embodiments, when the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described below, the server 106 may perform one or more functions related to an optimized data transfer between systems connected over a network.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

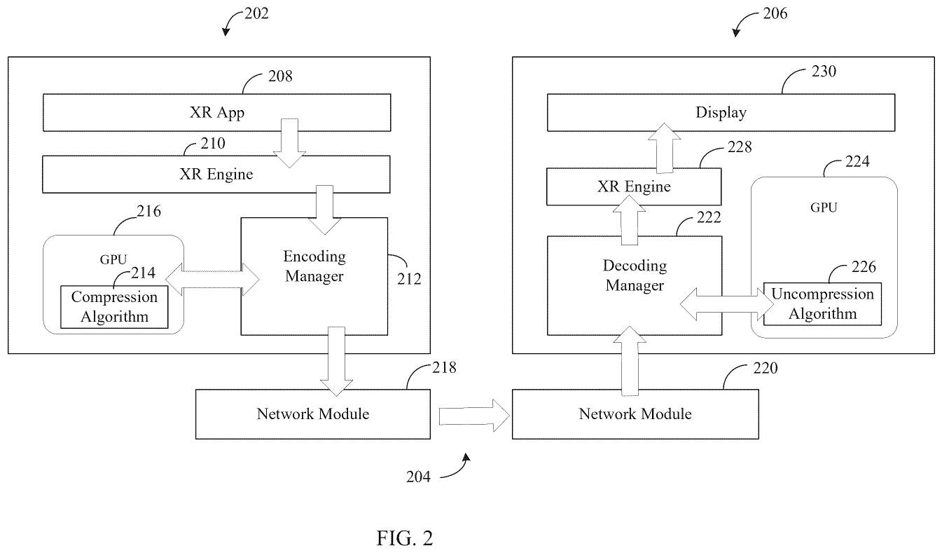

FIG. 2 illustrates an example process 200 for optimized data transfer between systems connected over a network in accordance with this disclosure. For case of explanation, the process 200 shown in FIG. 2 is described as being performed using the electronic device 101 in the network configuration 100 shown in FIG. 1. However, the process 200 shown in FIG. 2 may be performed using any other suitable device(s) and in any other suitable system(s).

As shown in FIG. 2, the process 200 includes a data compression operation 202, a data transfer operation 204, and a data uncompression operation 206. The data compression operation 202 can be performed by a first electronic device 101 (such as a PC), which may include an XR application 208, an XR engine 210, an encoding manager 212 executing a compression shader algorithm 214, and a GPU 216. The XR application 208 may be an application or software configured to run on an XR system (such as the electronic device 101) to generate XR content. In some cases, the XR application 208 may include a user-facing program that delivers an immersive experience, such as a game, simulation, or interactive environment.

The XR engine 210 may be a core software framework or platform that powers the XR application 208. In some cases, the XR engine 210 ensures a seamless interaction between the XR application 208 and the hardware of the electronic device 101 by performing tasks such as rendering 3D graphics and managing spatial tracking (like head and hand movement tracking). The XR engine 210 can obtain XR content from the XR application 208 and, based on the parameters associated with the XR content, utilize the encoding manager 212 (such as a texture encoding manager) to encode the XR content using the compression shader algorithm 214 operating on the GPU 216. For example, the XR application 208 may generate visual content, and the XR engine 210 may receive the content and one or more parameters (such as a desired resolution) for the XR content from the XR application 208. The XR engine 210 can transmit the parameter(s) and content to the encoding manager 212, which can encode the content using the compression shader algorithm 214.

The GPU 216 is a hardware component configured to render visuals in the XR system. Among other things, the GPU 216 can perform 3D rendering, texture mapping, and/or real-time redrawing of the content. In XR applications, the GPU 216 can process complex 3D graphics and deliver high frame rates (such as 90 FPS or higher) to prevent motion sickness and ensure a seamless user experience. For such seamless user experience, the compression shader algorithm 214 of the GPU 216 can operate to control rendering of pixels and vertices. For example, the compression shader algorithm 214 can calculate appropriate levels of light, darkness, and color during the rendering of digital (2D or 3D) images. Also, a falloff function can be utilized for the data compression operation. Based on the parameter(s), the encoding manager 212 may select a specific compression shader algorithm 214 to finalize the encoding of XR content. Example data compression of XR content is discussed further in detail below.

The encoding manager 212 may be a software or hardware module that manages the compression, decompression (uncompression), or organization of XR content data. For example, the encoding manager 212 may perform optimization tasks such as compression, format conversion, texture mapping, and encoding optimization. Upon finalizing the encoding of XR content, the encoding manager 212 can transmit the optimized content data (such as compressed rendered image frames) to a second electronic device 101.

The data transfer operation 204 generally operates to transfer the compressed data from the first electronic device 101 (such as a high-capacity computing device like a PC) to a second electronic device 101 (such as a VST headset). In this example, the data transfer operation 204 may be performed by network modules 218 and 220, which may represent the communication interfaces 170 of the first and second electronic devices 101.

The data uncompression operation 206 generally operates to uncompress the compressed data transferred from the first electronic device to generate a final image for rendering and displaying. The data uncompression operation 206 may be performed by the second electronic device 101. In this example, the second electronic device 101 may include a decoding manager 222, a GPU 224, an XR engine 228, and a display 230.

The decoding manager 222 may be a software or hardware module that manages the compression, uncompression, or organization of content data. For example, the decoding manager 222 may perform optimization tasks such as uncompression, format conversion, compression, texture mapping, and decoding optimization. Upon receiving XR content (such as compressed rendered image frames), the decoding manager 222 may select a specific uncompression algorithm 226 to uncompress the compressed XR content.

The uncompression algorithm 226 may represent a decompression shader GPU (similar to the GPU) 216 configured to decompress (uncompress) the compressed XR content on the GPU 224 to render final images of uncompressed image frames. For example, the GPU 224 may perform 3D rendering, texture mapping, and/or real-time redrawing of the uncompressed content. Upon finalizing the uncompression of the compressed XR content, the decoding manager 222 can transmit the uncompressed XR content to the XR engine 228. Further, an inverse falloff function can be utilized for the data uncompression operation. Example uncompression of the XR content is discussed further in detail below.

The XR engine 228 utilizes the uncompressed XR content for composition. For example, the XR engine 228 can combine the uncompressed XR content with other elements, such as lighting effects, other objects, UI overlays, or a real-world background captured from the second electronic device's imaging sensor(s) 180. Upon completing the composition, the XR engine 228 can obtain final image frames for rendering on the display 230, which may represent a display 160 of the second electronic device 101.

Although FIG. 2 illustrates one example of a process 200 for optimized data transfer between systems connected over a network, various changes may be made to FIG. 2. For example, various components or functions in FIG. 2 may be combined, further subdivided, replicated, omitted, or rearranged and additional components or functions may be added according to particular needs. Also, while described in the context of use in an XR application, the process 200 may be used for data transfers between any suitable systems for any suitable purposes.

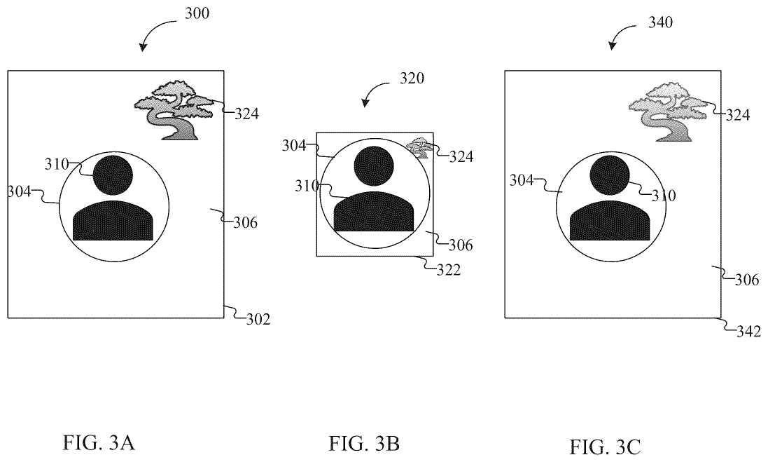

FIGS. 3A through 3C illustrate example functions in the process 200 of FIG. 2 in accordance with this disclosure. As shown in FIG. 3A, one operation associated with the process 200 is a data capture and rendering operation 300, which may occur as part of the data compression operation 202. The data capture and rendering operation 300 may be performed by the first electronic device 101 (such as a PC or a remote server). An original image frame 302 (like a source image frame or a source image) is captured by the electronic device 101, such as when an image frame is captured using one or more imaging sensors 180 of the electronic device 101. The source image frame 302 may represent an image frame of a scene captured by a forward-facing or other imaging sensor(s) 180 of the electronic device 101. In some cases, the source image frame 302 may represent a high-resolution color image frame (such as 2560×2560 pixels).

Any suitable pre-processing of the captured image frame may be performed here, such as noise filtering, lens distortion correction, color correction, edge enhancement, and artifact removal. In some cases, the source image frame 302 can be divided into two regions, namely a source foveal region 304 and a source peripheral region 306. The source foveal region 304 is a center region or other region on which a user focuses his or her gaze. In some cases, an ellipse may be used to parameterize this region 304. The source peripheral region 306 is a margin region in which all of the pixels thereof are located outside the source foveal region 304. In some embodiments, the source image may include a texture that a normalized coordinate space (such as a UV space) maps onto a 3D model. The center of the source foveal region 304 may not be aligned with a center of the source image frame 302.

As shown in FIG. 3B, another operation that may be associated with the process 200 is a data compression operation 320, which may occur as part of the data compression operation 202. During the operation 320, at least one processing device (such as the processor 120) of the electronic device 101 can compress the source image frame 302 to transfer the compressed source image frame 322 to a second electronic device. For example, the at least one processing device may compress the source image frame into a compressed image frame, such as one having a 1344×1504 resolution. However, the data compression operation 320 preserves the image quality of the source foveal region 304, such as by parameterizing it as an elliptical or polygonal region while compressing the source peripheral region 306.

In FIG. 3B, a center image 310 within the source foveal region 304 remains preserved, while a peripheral image 324 within the source peripheral region 306 has been compressed (such as distorted). This is because, during the data compression operation 320, the source foveal region 304 is allocated with more pixels to preserve the visual fidelity and thus encoded in a larger area compared to the source peripheral region 306, which may be allocated with significantly fewer pixels in the compressed format. This non-uniform compression technique causes the source peripheral images to become distorted. Example data compression is discussed further in detail below.

As shown in FIG. 3C, yet another operation that may be associated with the process 200 is a data uncompression operation 340, which may occur as part of the data uncompression operation 206. During the operation 340, the second electronic device 101 can uncompress the compressed source image frame to generate a final image for rendering and display the final image on the display 160. During the operation 340, the entire source image frame 302 can be reconstructed so that the fidelity of the source foveal region 304 is preserved at the expense of the source peripheral region's image quality. In some embodiments, the operation 340 may also undistort the distorted source peripheral image. Also, in some embodiments, the visual quality is not impacted (at least to any significant extent) since there is flexibility to set the source foveal region 304 to ensure that any blurred margin region stays in the user's peripheral vision. Example data uncompression is discussed further in detail below.

Although FIGS. 3A through 3C illustrate examples of functions in the process 200 shown in FIG. 2, various changes may be made to FIGS. 3A through 3C. For example, while the source foveal region 304 is illustrated as an elliptical region in these figures, it may be any polygonal region or other region.

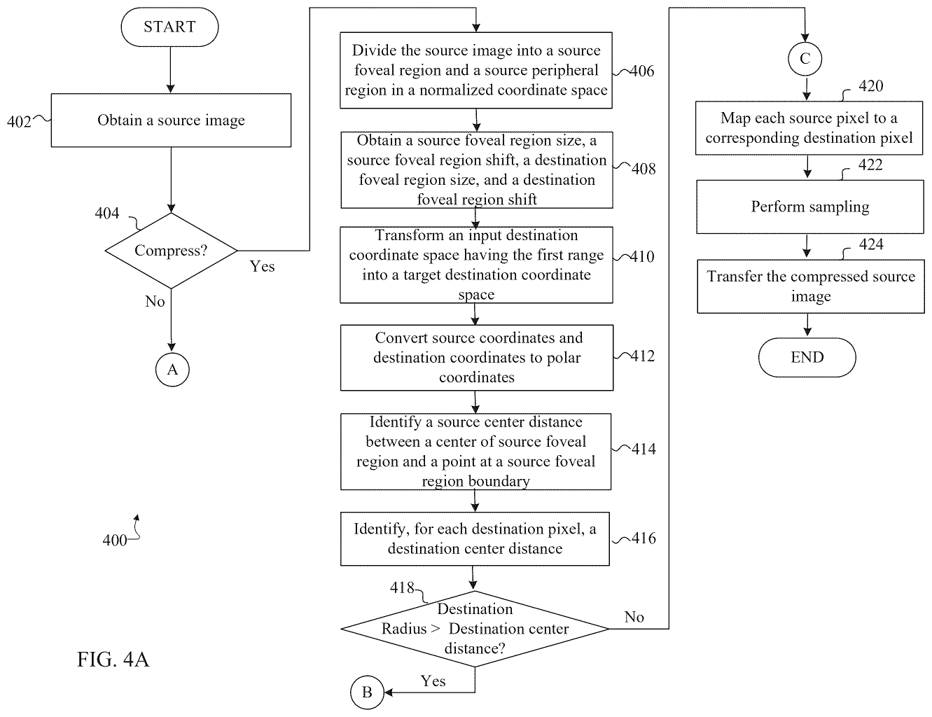

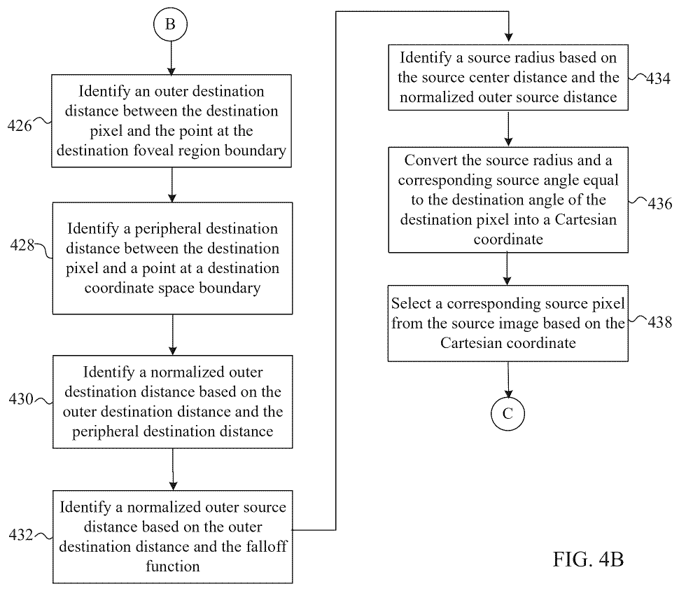

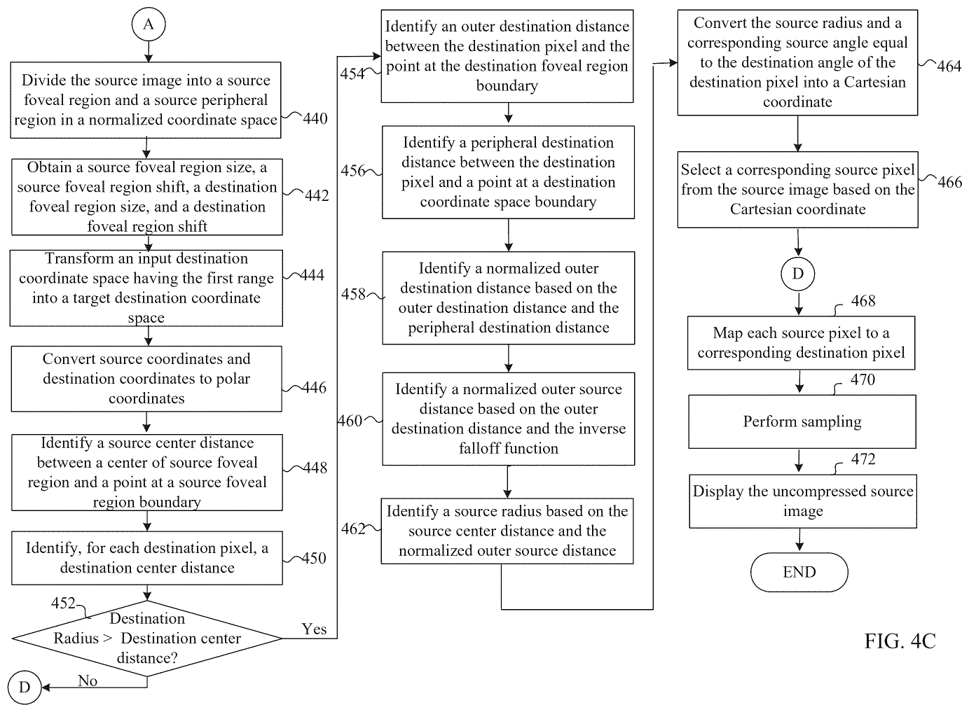

FIGS. 4A through 4C illustrate an example method 400 for performing optimized data transfer between systems connected in a network in accordance with this disclosure. For case of explanation, the method 400 shown in FIG. 4A through 4C is described as being performed using electronic devices 101 in the network configuration 100 shown in FIG. 1, where the electronic devices 101 may implement the process 200 shown in FIG. 2. However, the method 400 may be performed using any other suitable device(s) and in any other suitable system(s).

In some embodiments, the method 400 can be utilized for both the data compression operation 202 and the data uncompression operation 206 due to operational symmetry. Note that “source” and “destination” are used here and can vary depending on whether data compression or data uncompression is performed. For data compression, a source image refers to an original image, and a destination image refers to a compressed image. For data uncompression, a source image refers to a compressed image, and a destination image refers to an uncompressed image. Note that in the following discussions, various steps of the method 400 can be performed for each pixel in a destination image.

As shown in FIG. 4A, a source image is obtained at step 402. This may include, for example, the processor 120 of a first electronic device 101 (such as a PC or a remote server) obtaining a source image captured by at least one imaging sensor 180 or the processor 120 of a second electronic device 101 (such as a VST headset) obtaining a source image (compressed) from the first electronic device 101. At step 404, it is determined whether to compress the source image. If it is determined that the source image is to be compressed, at least one processing device (such as the processor 120) of the first electronic device 101 proceeds to perform data compression at step 406. If it is determined that the source image is to be uncompressed, the at least one processing device proceeds to perform data uncompression at step 440.

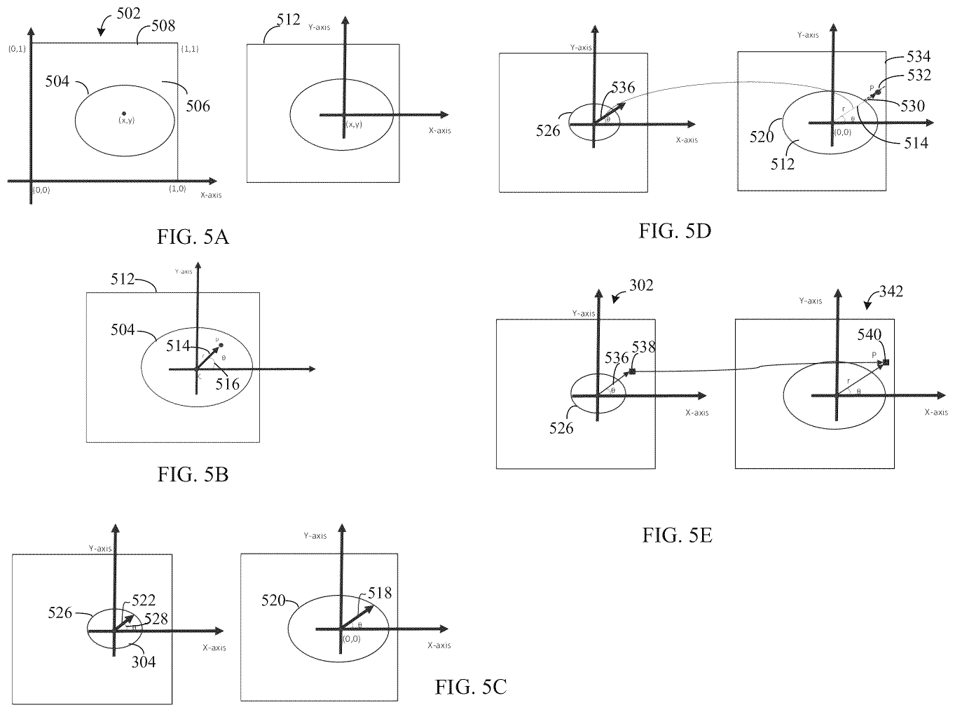

For data compression, the at least one processing device divides the source image into a source foveal region and a source peripheral region in a normalized coordinate space at step 406. The normalized coordinate space (such as a UV space) may have a first range, such as [0,1]. The source foveal region need not be aligned (can be shifted) at the center of the coordinate space. The at least one processing device obtains source image data, such as a source foveal region size, a source foveal region shift from the center of the normalized coordinate space, a destination foveal region size, and a destination foveal region shift from a center of the destination coordinate space, at step 408. Based on the source image data, the at least one processing device may transform (adjust) an input destination coordinate space having the first range into a target destination coordinate space having another range at step 410. For example, the input destination coordinate space having UV coordinates in the range [0,1]×[0,1] may be adjusted to be in a second range, an example of which is shown in FIG. 5A. The second range may be any appropriate range, such as [0.5, 0.5]×[0.5,0.5], with the destination foveal region shift coinciding with the origin at the location (0,0). The adjusted range may have other min-max values, in some cases as long as the destination foveal region can be shifted to the location (0,0).

At step 412, the at least one processing device converts source coordinates and destination coordinates to polar coordinates, including a source radius and a source angle for each source pixel and a destination radius and a destination angle for each destination pixel. In some cases, the at least one processing device computes the destination radius r and destination angles θ. For example, the destination radius r, sin θ, cos θ, and tan θ can be obtained for a pixel at (x,y) in a destination image during the data compression operation. That is, the coordinates from a Cartesian system (such as the (x,y) format) can be converted to polar coordinates in a polar system (such as the (r,θ) format). An example of this conversion is illustrated further with reference to FIG. 5B.

At step 414, the at least one processing device identifies, for each source pixel, a source center distance between the center of the source foveal region and a point at a source foveal region boundary. At step 416, the at least one processing device identifies, for each destination pixel, a destination center distance between a center of the destination foveal region and a point at a destination foveal region boundary. For example, the at least one processing device may compute the destination and source center region boundary distances using the source radius and source angle for each source pixel and the destination radius and destination angle for each destination pixel. An example of this computation is illustrated further with reference to FIG. 5C. Note that a constant angle θ may be used here to compute the distances.

At step 418, the at least one processing device compares a destination radius of each destination pixel to the destination center distance. If the destination radius is not greater than the destination center distance, the at least one processing device determines a source pixel having a corresponding source radius and a corresponding source angle in the source image and maps the source pixel to the corresponding destination pixel without compression at step 420.

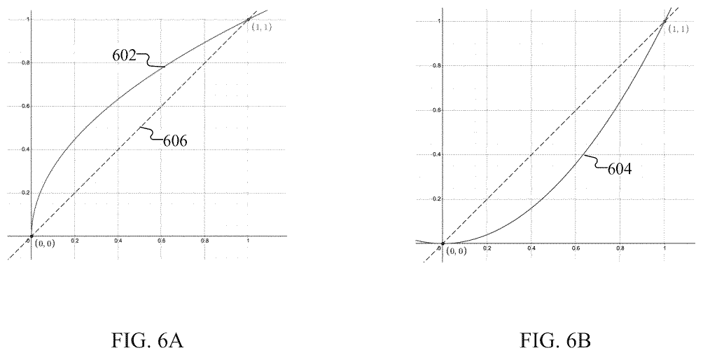

If the destination radius is greater than the destination center distance, the at least one processing device identifies an outer destination distance between the destination pixel and the point at the destination foveal region boundary at step 426. The at least one processing device further identifies a peripheral destination distance between the destination pixel (extended to touch the image boundary (the target destination coordinate space boundary)) and a point at a destination coordinate space boundary at step 428. At step 430, the at least one processing device identifies a normalized outer destination distance based on the outer destination distance and the peripheral destination distance. At step 432, the at least one processing device identifies a normalized outer source distance based on the normalized outer destination distance and a falloff function. In some cases, the normalized outer destination distance may be between the value of [0,1] due to its normalization to be in that range. This normalized outer destination distance is passed through a falloff function to obtain the normalized outer source distance, such as the normalized outer destination distance→the falloff function→the normalized outer source distance. An example of these computations is illustrated in FIG. 5D. Since the input to the falloff function may be in the [0,1] range, the output is also in the [0,1] range. An example falloff function y=x², is illustrated in FIG. 6B.

At step 434, the at least one processing device identifies a source radius by adding the source center distance and the normalized outer source distance. At step 436, the at least one processing device converts the source radius and a corresponding source angle equal to the destination angle of the destination pixel into a Cartesian coordinate. That is, with the source radius and the source angle θ (which is the same as the destination angle θ), the at least one processing device can convert these polar coordinates to Cartesian coordinate system UV values. At step 438, the at least one processing device selects a corresponding source pixel from the source image based on the Cartesian coordinate. The at least one processing device proceeds to step 420 and maps the corresponding source pixel to the destination pixel. Thus, the destination image in the target destination coordinate space now includes the compressed pixels from steps 426-438 and the preserved pixels within the source foveal region.

At step 422, the at least one processing device performs sampling. For example, the at least one processing device may sample the pixels from the source image to the target destination space for data transfer. At step 424, a network module (such as the communication interface 170) transfers the compressed source image to the second electronic device.

As shown in FIG. 4C, for data uncompression, the at least one processing device performs substantially identical steps, except that it utilizes an inverse falloff function for uncompression and displays the uncompressed source image upon rendering. At step 440, the at least one processing device divides the source image into a source foveal region and a source peripheral region in a normalized coordinate space. At step 442, the at least one processing device obtains a source foveal region size, a source foveal region shift from the center of the normalized coordinate space, a destination foveal region size, and a destination foveal region shift from a center of the destination coordinate space. At step 444, the at least one processing device transforms an input destination coordinate space having the first range into a target destination coordinate space having a second range different from the first range.

At step 446, the at least one processing device converts source and destination coordinates to polar coordinates, including a source radius and a source angle for each source pixel and a destination radius and a destination angle for each destination pixel. At step 448, the at least one processing device identifies, for each source pixel, a source center distance between the center of the source foveal region and a point at a source foveal region boundary. At step 450, the at least one processing device identifies, for each destination pixel, a destination center distance between a center of the destination foveal region and a point at a destination foveal region boundary. At step 452, the at least one processing device compares a destination radius of each destination pixel to the destination center distance. If the destination radius is not greater than the destination center distance, the at least one processing device determines a source pixel having a corresponding source radius and a corresponding source angle in the source image and maps the source pixel to the corresponding destination pixel without uncompression at step 468.

If the destination radius is greater than the destination center distance, the at least one processing device identifies an outer destination distance between the destination pixel and the point at the destination foveal region boundary at step 454. The at least one processing device further identifies a peripheral destination distance between the destination pixel (extended to touch the image boundary, the target destination coordinate space boundary) and a point at a destination coordinate space boundary at step 456. At step 458, the at least one processing device identifies a normalized outer destination distance based on the outer destination distance and the peripheral destination distance. At step 460, the at least one processing device identifies a normalized outer source distance based on the normalized outer destination distance and an inverse falloff function. That is, the normalized outer destination distance may be between the value of [0,1] due to its normalization to be in that range. This normalized outer destination distance is passed through the inverse falloff function to obtain the normalized outer source distance, such as the normalized outer destination distance→the inverse falloff function→the normalized outer source distance. An example inverse falloff function y=\sqrt{x} is illustrated in FIG. 6A.

At step 462, the at least one processing device identifies a source radius by adding the source center distance and the normalized outer source distance. At step 464, the at least one processing device converts the source radius and a corresponding source angle equal to the destination angle of the destination pixel into a Cartesian coordinate. At step 466, the at least one processing device selects a corresponding source pixel from the source image based on the Cartesian coordinate. The at least one processing device proceeds to step 468 and maps the corresponding source pixel to the destination pixel. Thus, the destination image now includes the uncompressed pixels from steps 454 through 466 and the preserved pixels within the source foveal region in the target destination coordinate space.

At step 468, the at least one processing device performs sampling. For example, the at least one processing device may sample the pixels from the source image to the target destination space to generate a final image (of the uncompressed source image) for rendering. At step 470, the second electronic device displays the final image on a display (such as a display 160).

In some embodiments, a polynomial-based falloff function may be used to ensure a non-linear visual quality fall-off. The margin (peripheral) region can also incorporate lens distortion parameters for a more aggressive visual quality fall-off. Also, in some embodiment, since a configurable center (foveal) region is utilized, it can easily be extended to incorporate eye gaze tracking data. For example, the center region's location and size may change depending on the current eye gaze data. In addition, in some embodiments, different shapes for the center region may be used. While an elliptical center region is one form, the compression/uncompression algorithm can be extended to have any other shape, such as a rectangle, hexagon, etc. These features may be useful in adapting to different XR devices with different lens geometries or other use cases.

Although FIGS. 4A through 4C illustrate one example of a method 400 for optimized data transfer between systems connected over a network, various changes may be made to FIGS. 4A through 4C. For example, while shown as a series of steps, various steps in FIGS. 4A through 4C may overlap, occur in parallel, occur in a different order, or occur any number of times (including zero times). Also, while described in the context of use in an XR application, the method 400 may be used for data transfers between any suitable systems for any suitable purposes.

FIGS. 5A through 5E illustrate various steps of the method 400 in accordance with this disclosure. FIG. 5A illustrates example operations in step 410 of the method 400. An input destination coordinate space 410 has UV coordinates in the range [0,1]. A destination image frame 502 has been divided into a destination foveal region 504 and a destination peripheral region 506 in a normalized input destination coordinate space 508. The destination foveal region 504 is not aligned (is shifted) at the center of the input destination coordinate space 508. Based on the destination image data, at least one processing device may transform (adjust) the input destination coordinate space 508 having the first range into a target destination coordinate space 512 having a second range. For example, the input destination coordinate space 508 having UV coordinates in the range [0,1]×[0,1] may be adjusted to be in a second range different from the first range. The second range may be any appropriate range, such as [0.5, 0.5]×[0.5,0.5].

FIG. 5B illustrates example operations in step 412 of the method 400. In the target destination coordinate space 512, the destination coordinates in the Cartesian system are converted into polar coordinates. For example, at least one processing device can compute a destination radius r 514 and destination angles θ 516. In FIG. 5B, a pixel P is disposed within the destination foveal region 504 and has a destination radius r 514 and a destination angle θ 516. The destination radius r 514 is measured from the center C of the destination foveal region (such as location (0,0)). Based on the polar coordinates, the sin θ, cos θ, and tan θ values are obtained for compression.

FIG. 5C illustrates example operations in step 414 of the method 400. At least one processing device identifies, for each destination pixel, a destination center distance 518 between a center C of the destination foveal region 504 and a point at a destination foveal region boundary 520. The at least one processing device also computes a source center distance 522 between the center of the source foveal region 304 and a point at a source foveal region boundary 526. The at least one processing device can compute the destination and source center region boundary distances using a source radius r (the same as the source center distance 522) and source angle θ 528 for each source pixel and the destination radius r 514 and destination angle θ 516 for each destination pixel.

FIG. 5D illustrates example operations in steps 418 and 426-436 of the method 400. In the target destination coordinate space 512, at least one processing device compares the destination radius r 514 of each destination pixel to the destination center distance 518. If the destination radius r 514 is not greater than the destination center distance 518, the at least one processing device determines a source pixel having a corresponding source radius and a corresponding source angle in the source image and maps the source pixel to the corresponding destination pixel without compression.

If the destination pixel P is located outside of the destination foveal region 504 and thus has a destination radius r 514 that is greater than the destination center distance 518, the at least one processing device identifies an outer destination distance 530 between the destination pixel P and the point at the destination foveal region boundary 520. The at least one processing device also identifies a peripheral destination distance 532 between the destination pixel P (which has been extended to touch the image boundary (the same as a destination coordinate space boundary) 534) and a point at a destination coordinate space boundary 534. That is, the peripheral destination distance 532 is the maximum distance to which the pixel P could be extended, such as a distance between the destination foveal region boundary 520 and the image boundary 534. The at least one processing device identifies a normalized outer destination distance based on the outer destination distance 530 and the peripheral destination distance 532. The normalized outer destination distance can be between the value of [0,1] due to its normalization to be in that range. This normalized outer destination distance is passed through the falloff function to obtain the normalized outer source distance. The at least one processing device identifies a source radius 536 by adding the source center distance 522 and the normalized outer source distance.

FIG. 5E illustrates example operations in step 438 of the method 400. Based on the source radius 536 and the source angle θ (which is the same as the destination angle θ), at least one processing device converts these polar coordinates to Cartesian coordinate system UV values. The at least one processing device selects a corresponding source pixel 538 from the source image frame 302 (FIG. 3A) based on the Cartesian coordinate and places the source pixel 538 in the corresponding location 540 in the destination image 342 (FIG. 3A).

Although FIGS. 5A through 5E illustrate examples of steps of the method 400 of FIGS. 4A through 4C, various changes may be made to FIGS. 5A through 5E. For example, while each of these steps utilizes an elliptical foveal region for both source and destination coordinate spaces, any polygonal shape or other shape can be utilized.

FIGS. 6A and 6B illustrate example falloff and inverse falloff functions utilized in the optimized data transfer between systems connected over a network in accordance with this disclosure. More specifically, FIG. 6A shows an example uncompression inverse falloff curve 602 of the inverse falloff function y=\sqrt{x}, and FIG. 6B shows an example compression falloff curve 604 of a falloff function y=x². Both curves 602 and 604 are shown together with a reference curve 606 of a function y=x.

Although FIGS. 6A and 6B illustrate examples of inverse falloff and falloff functions utilized in the optimized data transfer between systems connected over a network, may be made to FIGS. 6A and 6B. For example, any other appropriate inverse falloff and falloff functions can be utilized.

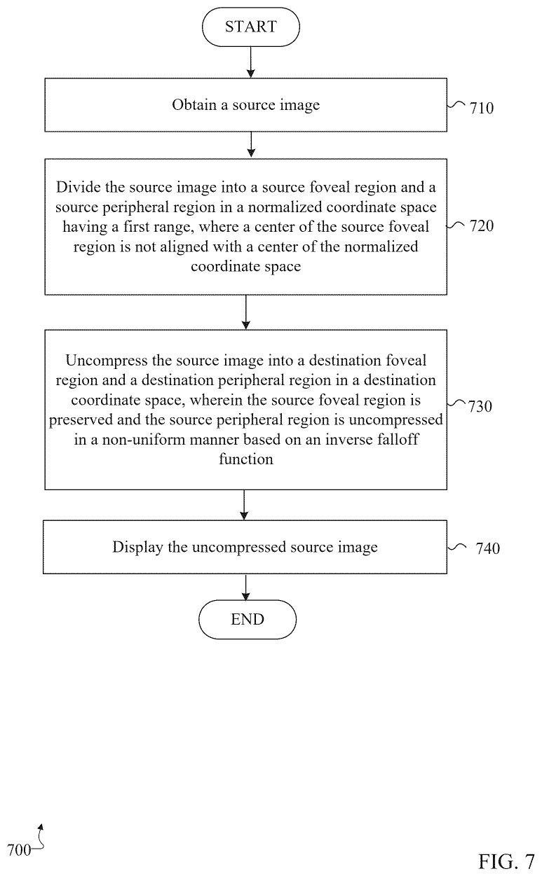

FIG. 7 illustrates an example method 700 for uncompressing a compressed image transferred between systems in a network in accordance with this disclosure. For case of explanation, the method 700 shown in FIG. 7 is described as being performed using the electronic device 101 in the network configuration 100 shown in FIG. 1, where the electronic device 101 may implement the process 200 shown in FIG. 2. However, the method 700 may be performed using any other suitable device(s) and in any other suitable system(s).

As shown in FIG. 7, a source image is obtained at step 710. This may include, for example, the processor 120 of the electronic device 101 obtaining a source image from another electronic device 101. At step 720, the source image is divided into a source foveal region and a source peripheral region in a normalized coordinate space having a first range. A center of the source foveal region may not be aligned with a center of the normalized coordinate space.

At step 730, the source image is uncompressed for display. This may include, for example, the processor 120 of the electronic device 101 obtaining a source foveal region size, a source foveal region shift from the center of the normalized coordinate space, a destination foveal region size, and a destination foveal region shift from a center of the destination coordinate space. This may also include the processor 120 of the electronic device 101 transforming an input destination coordinate space having the first range into a target destination coordinate space and converting source coordinates and destination coordinates to polar coordinates including a source radius and a source angle for each source pixel and a destination radius and a destination angle for each destination pixel. This may further include the processor 120 of the electronic device 101 identifying, for each source pixel, a source center distance between the center of the source foveal region and a point at a source foveal region boundary and identifying, for each destination pixel, a destination center distance between a center of the destination foveal region and a point at a destination foveal region boundary. This may also include the processor 120 of the electronic device 101 comparing a destination radius of each destination pixel to the destination center distance and mapping each source pixel from the source image to a corresponding destination pixel in the target destination coordinate space based on at least one of the comparison and the inverse falloff function.

To map each source pixel to a corresponding destination pixel having a destination radius less than the destination center distance, the processor 120 of the electronic device 101 may determine a source pixel having a corresponding source radius and a corresponding source angle in the source image and map the source pixel to the destination pixel. To map each source pixel to a corresponding destination pixel having a destination radius greater than the destination center distance, the processor 120 of the electronic device 101 may identify an outer destination distance between the destination pixel and the point at the destination foveal region boundary, identify a peripheral destination distance between the destination pixel and a point at a destination coordinate space boundary, identify a normalized outer destination distance based on the outer destination distance and the peripheral destination distance, identify a normalized outer source distance based on the normalized outer destination distance and the inverse falloff function, identify a source radius based on the source center distance and the normalized outer source distance, convert the source radius and a corresponding source angle equal to the destination angle of the destination pixel into a Cartesian coordinate, select a corresponding source pixel from the source image based on the Cartesian coordinate, and map the corresponding source pixel to the destination pixel. The source image may be uncompressed further by applying one of linear falloff function or polynomial-based falloff function to the destination peripheral region. The destination peripheral region may incorporate one or more lens distortion parameters for the inverse falloff function. The source foveal region may be adjusted based on eye gaze tracking data. Each of the source foveal region and the destination foveal region may have an elliptical or polygonal shape.

At step 740, the uncompressed source image is displayed. This may include, for example, the processor 120 of the electronic device 101 initiating presentation of a final image of the uncompressed source image frame on a display 160 of a second electronic device 101.

Although FIG. 7 illustrates one example of a method 700 for optimized data transfer between systems connected over a network, various changes may be made to FIG. 7. For example, while shown as a series of steps, various steps in FIG. 7 may overlap, occur in parallel, occur in a different order, or occur any number of times (including zero times).

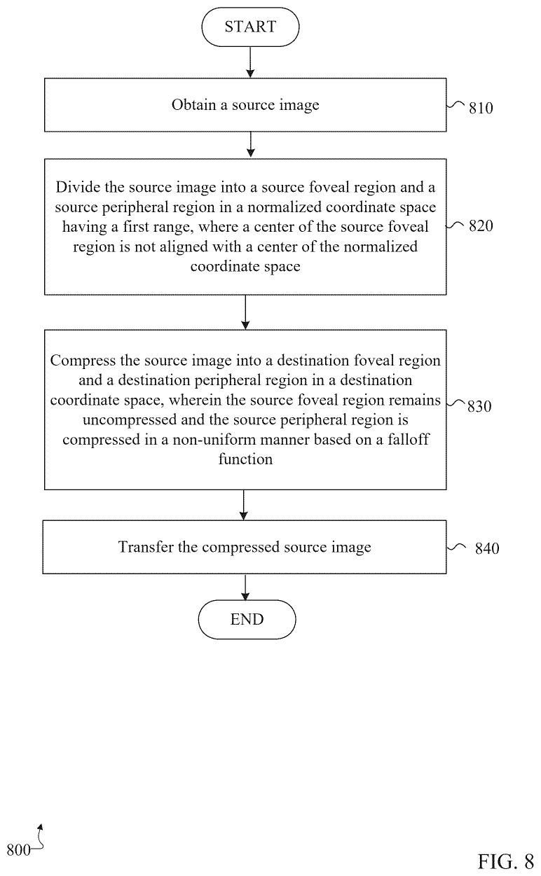

FIG. 8 illustrates an example method 800 for compressing an image to be transferred between systems in a network in accordance with this disclosure. For case of explanation, the method 800 shown in FIG. 8 is described as being performed using the electronic device 101 in the network configuration 100 shown in FIG. 1, where the electronic device 101 may implement the process 200 shown in FIG. 2. However, the method 800 may be performed using any other suitable device(s) and in any other suitable system(s).

As shown in FIG. 8, a source image is obtained at step 810. This may include, for example, the processor 120 of the electronic device 101 obtaining a source image captured using one or more imaging sensors 180 of the electronic device 101. At step 820, the source image is divided into a source foveal region and a source peripheral region in a normalized coordinate space having a first range. A center of the source foveal region may not be aligned with a center of the normalized coordinate space.

At step 830, the source image is compressed. This may include, for example, the processor 120 of the electronic device 101 obtaining a source foveal region size, a source foveal region shift from the center of the normalized coordinate space, a destination foveal region size, and a destination foveal region shift from a center of the destination coordinate space. This may also include the processor 120 of the electronic device 101 transforming an input destination coordinate space having the first range into a target destination coordinate space and converting source coordinates and destination coordinates to polar coordinates including a source radius and a source angle for each source pixel and a destination radius and a destination angle for each destination pixel. This may further include the processor 120 of the electronic device 101 identifying, for each source pixel, a source center distance between the center of the source foveal region and a point at a source foveal region boundary and identifying, for each destination pixel, a destination center distance between a center of the destination foveal region and a point at a destination foveal region boundary. In addition, this may include the processor 120 of the electronic device 101 comparing a destination radius of each destination pixel to the destination center distance and mapping each source pixel from the source image to a corresponding destination pixel in the target destination coordinate space based on at least one of the comparison and the falloff function.

To map each source pixel to a corresponding destination pixel having a destination radius less than the destination center distance, the processor 120 of the electronic device 101 may determine a source pixel having a corresponding source radius and a corresponding source angle in the source image and map the source pixel to the destination pixel without compression. To map each source pixel to a corresponding destination pixel having a destination radius greater than the destination center distance, the processor 120 of the electronic device 101 may identify an outer destination distance between the destination pixel and the point at the destination foveal region boundary, identify a peripheral destination distance between the destination pixel and a point at a destination coordinate space boundary, identify a normalized outer destination distance based on the outer destination distance and the peripheral destination distance, identify a normalized outer source distance based on the normalized outer destination distance and the falloff function, identify a source radius based on the source center distance and the normalized outer source distance, convert the source radius and a corresponding source angle equal to the destination angle of the destination pixel into a Cartesian coordinate, select a corresponding source pixel from the source image based on the Cartesian coordinate, and map the corresponding source pixel to the destination pixel. The source image may be compressed further by applying one of linear falloff function or polynomial-based falloff function to the destination peripheral region. The destination peripheral region may incorporate one or more lens distortion parameters for the inverse falloff function. The source foveal region may be adjusted based on eye gaze tracking data. Each of the source foveal region and the destination foveal region may have an elliptical or polygonal shape.

At step 840, the compressed source image is transferred. This may include, for example, the communication interface 170 of the electronic device 101 transferring the compressed source image frame to a second electronic device 101 connected to the electronic device 101 over a network.

Although FIG. 8 illustrates one example of a method 800 for optimized data transfer between systems connected over a network, various changes may be made to FIG. 8. For example, while shown as a series of steps, various steps in FIG. 8 may overlap, occur in parallel, occur in a different order, or occur any number of times (including zero times).

It should be noted that the functions shown in or described with respect to FIGS. 2 through 8 can be implemented in an electronic device 101, 102, 104, server 106, or other device(s) in any suitable manner. For example, in some embodiments, at least some of the functions shown in or described with respect to FIGS. 2 through 8 can be implemented or supported using one or more software applications or other software instructions that are executed by the processor 120 of the electronic device 101, 102, 104, server 106, or other device(s). In other embodiments, at least some of the functions shown in or described with respect to FIGS. 2 through 8 can be implemented or supported using dedicated hardware components. In general, the functions shown in or described with respect to FIGS. 2 through 8 can be performed using any suitable hardware or any suitable combination of hardware and software/firmware instructions. Also, the functions shown in or described with respect to FIGS. 2 through 8 can be performed by a single device or by multiple devices.

Although this disclosure has been described with example embodiments, various changes and modifications may be suggested to one skilled in the art. It is intended that this disclosure encompass such changes and modifications as fall within the scope of the appended claims.

What is claimed is:

1. A method comprising:
obtaining, using at least one processing device of a first electronic device, a source image;
dividing, using the at least one processing device, the source image into a source foveal region and a source peripheral region in a normalized coordinate space having a first range, wherein a center of the source foveal region is not aligned with a center of the normalized coordinate space;
uncompressing, using the at least one processing device, the source image into a destination foveal region and a destination peripheral region in a destination coordinate space, wherein the source foveal region is preserved and the source peripheral region is uncompressed in a non-uniform manner based on an inverse falloff function; and
displaying the uncompressed source image.

2. The method of claim 1, wherein uncompressing the source image comprises:
obtaining a source foveal region size, a source foveal region shift from the center of the normalized coordinate space, a destination foveal region size, and a destination foveal region shift from a center of the destination coordinate space;
transforming an input destination coordinate space having the first range into a target destination coordinate space;
converting source coordinates and destination coordinates to polar coordinates including a source radius and a source angle for each source pixel and a destination radius and a destination angle for each destination pixel;
identifying, for each source pixel, a source center distance between the center of the source foveal region and a point at a source foveal region boundary;
identifying, for each destination pixel, a destination center distance between a center of the destination foveal region and a point at a destination foveal region boundary;
comparing a destination radius of each destination pixel to the destination center distance; and
mapping each source pixel from the source image to a corresponding destination pixel in the target destination coordinate space based on at least one of the comparison and the inverse falloff function.

3. The method of claim 2, wherein mapping each source pixel to the corresponding destination pixel includes:
for each destination pixel having the destination radius less than the destination center distance:
determining a source pixel having a corresponding source radius and a corresponding source angle in the source image; and
mapping the source pixel to the destination pixel; and
for each destination pixel having the destination radius greater than the destination center distance:
identifying an outer destination distance between the destination pixel and the point at the destination foveal region boundary;
identifying a peripheral destination distance between the destination pixel and a point at a destination coordinate space boundary;
identifying a normalized outer destination distance based on the outer destination distance and the peripheral destination distance;
identifying a normalized outer source distance based on the normalized outer destination distance and the inverse falloff function;
identifying a source radius based on the source center distance and the normalized outer source distance;
converting the source radius and a corresponding source angle equal to the destination angle of the destination pixel into a Cartesian coordinate;
selecting a corresponding source pixel from the source image based on the Cartesian coordinate; and
mapping the corresponding source pixel to the destination pixel.

4. The method of claim 2, wherein uncompressing the source image further comprises:
applying one of a linear falloff function or a polynomial-based falloff function to the destination peripheral region.

5. The method of claim 1, wherein the destination peripheral region incorporates one or more lens distortion parameters for the inverse falloff function.

6. The method of claim 1, wherein the source foveal region is adjusted based on eye gaze tracking data.

7. The method of claim 1, wherein each of the source foveal region and the destination foveal region has an elliptical or polygonal shape.

8. A method comprising:
obtaining, using at least one processing device of a first electronic device, a source image;
dividing, using the at least one processing device, the source image into a source foveal region and a source peripheral region in a normalized coordinate space having a first range, wherein a center of the source foveal region is not aligned with a center of the normalized coordinate space;
compressing, using the at least one processing device, the source image into a destination foveal region and a destination peripheral region in a destination coordinate space, wherein the source foveal region remains uncompressed and the source peripheral region is compressed in a non-uniform manner based on a falloff function; and
transferring, to a second electronic device, the compressed source image.

9. The method of claim 8, wherein compressing the source image comprises:
obtaining a source foveal region size, a source foveal region shift from the center of the normalized coordinate space, a destination foveal region size, and a destination foveal region shift from a center of the destination coordinate space;
transforming an input destination coordinate space having the first range into a target destination coordinate space;
converting source coordinates and destination coordinates to polar coordinates including a source radius and a source angle for each source pixel and a destination radius and a destination angle for each destination pixel;
identifying, for each source pixel, a source center distance between the center of the source foveal region and a point at a source foveal region boundary;
identifying, for each destination pixel, a destination center distance between a center of the destination foveal region and a point at a destination foveal region boundary;
comparing a destination radius of each destination pixel to the destination center distance; and
mapping each source pixel from the source image to a corresponding destination pixel in the target destination coordinate space based on at least one of the comparison and the falloff function.

10. The method of claim 9, wherein mapping each source pixel to the corresponding destination pixel includes:
for each destination pixel having the destination radius less than the destination center distance:
determining a source pixel having a corresponding source radius and a corresponding source angle in the source image; and
mapping the source pixel to the destination pixel without compression; and
for each destination pixel having the destination radius greater than the destination center distance:
identifying an outer destination distance between the destination pixel and the point at the destination foveal region boundary;
identifying a peripheral destination distance between the destination pixel and a point at a destination coordinate space boundary;
identifying a normalized outer destination distance based on the outer destination distance and the peripheral destination distance;
identifying a normalized outer source distance based on the normalized outer destination distance and the falloff function;
identifying a source radius based on the source center distance and the normalized outer source distance;
converting the source radius and a corresponding source angle equal to the destination angle of the destination pixel into a Cartesian coordinate;
selecting a corresponding source pixel from the source image based on the Cartesian coordinate; and
mapping the corresponding source pixel to the destination pixel.

11. The method of claim 9, wherein compressing the source image further comprises:
applying one of a linear falloff function or a polynomial-based falloff function to the destination peripheral region.

12. The method of claim 8, wherein the destination peripheral region incorporates one or more lens distortion parameters for the falloff function.

13. The method of claim 8, wherein the source foveal region is adjusted based on eye gaze tracking data.

14. The method of claim 8, wherein each of the source foveal region and the destination foveal region has an elliptical or polygonal shape.

15. An electronic device comprising:
at least one processing device configured to:
obtain a source image;
divide the source image into a source foveal region and a source peripheral region in a normalized coordinate space having a first range, wherein a center of the source foveal region is not aligned with a center of the normalized coordinate space;
uncompress the source image into a destination foveal region and a destination peripheral region in a destination coordinate space, wherein the source foveal region is preserved and the source peripheral region is uncompressed in a non-uniform manner based on an inverse falloff function; and
initiate display of the uncompressed source image.

16. The electronic device of claim 15, wherein, to uncompress the source image, the at least one processing device is configured to:
obtain a source foveal region size, a source foveal region shift from the center of the normalized coordinate space, a destination foveal region size, and a destination foveal region shift from a center of the destination coordinate space;
transform an input destination coordinate space having the first range into a target destination coordinate space;
convert source coordinates and destination coordinates to polar coordinates including a source radius and a source angle for each source pixel and a destination radius and a destination angle for each destination pixel;
identify, for each source pixel, a source center distance between the center of the source foveal region and a point at a source foveal region boundary;
identify, for each destination pixel, a destination center distance between a center of the destination foveal region and a point at a destination foveal region boundary;
compare a destination radius of each destination pixel to the destination center distance; and
map each source pixel from the source image to a corresponding destination pixel in the target destination coordinate space based on at least one of the comparison and the inverse falloff function.

17. The electronic device of claim 16, wherein, to map each source pixel to the corresponding destination pixel, the at least one processing device is configured to:
for each destination pixel having the destination radius less than the destination center distance:
determine a source pixel having a corresponding source radius and a corresponding source angle in the source image; and
map the source pixel to the destination pixel; and
for each destination pixel having the destination radius greater than the destination center distance:
identify an outer destination distance between the destination pixel and the point at the destination foveal region boundary;
identify a peripheral destination distance between the destination pixel and a point at a destination coordinate space boundary;
identify a normalized outer destination distance based on the outer destination distance and the peripheral destination distance;
identify a normalized outer source distance based on the normalized outer destination distance and the inverse falloff function;
identify a source radius based on the source center distance and the normalized outer source distance;
convert the source radius and a corresponding source angle equal to the destination angle of the destination pixel into a Cartesian coordinate;
select a corresponding source pixel from the source image based on the Cartesian coordinate; and
map the corresponding source pixel to the destination pixel.

18. The electronic device of claim 16, wherein, to uncompress the source image, the at least one processing device is further configured to apply one of a linear falloff function or a polynomial-based falloff function to the destination peripheral region.

19. The electronic device of claim 15, wherein the destination peripheral region incorporates one or more lens distortion parameters for the inverse falloff function.

20. The electronic device of claim 15, wherein each of the source foveal region and the destination foveal region has an elliptical or polygonal shape.
